(19) United States
(12) Patent Application Publication
(10) Pub. No.: US 2019/0091781 A1
(43) Pub. Date: Mar. 28, 2019

(54) SAW HAVING A DUST COLLECTOR

(71) Applicant: Scheppach Fabrikation von Holzbearbeitungsmaschinen GmbH, Ichenhausen (DE)

(72) Inventor: Markus Bindhammer, Friedberg (DE)

(21) Appl. No.: 16/135,939

(22) Filed: Sep. 19, 2018

(30) Foreign Application Priority Data
Sep. 22, 2017 (EP) 17 020 438.2

(51) Int. Cl. B23D 59/00; B23Q 11/00; B27G 19/04; B27G 3/00

(52) U.S. Cl. CPC B23D 59/006; B23Q 11/0046; B28D 7/02; B27G 3/00; B27G 19/04

(57) ABSTRACT

A saw has a machine head mounted on a machine frame to be pivotable in a vertical plane and to be pressable downwards for sawing from a rest position and which carries a saw blade rotating for sawing. The saw has a dust collector, serving to receive the chips and dust produced during sawing, connecting to a connection socket on a saw blade cover mounted above the saw blade on the machine head, being displaceably arranged on a carriage received in a linear guide, and being connected to the connection socket via a flexible connecting line. When the machine head is pressed down, the dust collector makes a linear displacement movement, the saw blade cover and the dust collector move relative to the machine frame, and the bendability or flexibility of the connecting line between the connection socket and the dust collector compensates for the different directions of movement.

### CROSS REFERENCE TO RELATED APPLICATIONS

This application claims priority to European patent application EP 17 020 438.2, filed Sep. 22, 2017, the entire content of which is incorporated herein by reference.

### TECHNICAL FIELD

The invention relates to a saw, in particular to a chop saw, miter saw or slide compound miter saw.

### BACKGROUND

The saw has a machine frame and a swivel-mounted machine head which carries the saw blade. For example, the machine frame may take the form of a stand connected to a table or a base on which the machine head is hinged and may be biased to a rest position raised from the table or base from which rest position it is pressed down for sawing.

In most cases, a dust bag is provided, which is attached to a suction socket on a saw blade guard covering the top of the saw blade, in order to collect dust and chips that are produced during cutting. The air flow generated by the rotating saw blade is used here. Dust and chips are carried along and are collected in the dust bag. Such a saw is shown for example in the European patent application EP 1 990 121 A1.

The disadvantage of this is that the dust bag moves along with the machine head when the machine head is swiveled in for sawing. When the machine head is pressed down for sawing, the dust bag is almost in vertical position above the saw blade. In this position, the air flow is often no longer sufficient to transport dust and chips into the dust bag and hold it there.

US patent application US 2004/0089125 A1 describes a dust bag that is fixed to a bed and held in shape on the machine frame and therefore does not swivel downwards even when the machine head is pivoted. The necessary mobility is provided by a flexible connection neck of the dust collection bag, to which the dust removal tube leading into an area of the saw blade is connected, which dust removal tube is then pushed away from the saw blade cover when the machine head is pressed down.

European patent application EP 1 625 908 A1 describes a sliding compound miter saw with a flexible hose connected to the saw blade cover, which leads to a cyclone, which opens into a dust collection container arranged below. The dust collector is attached to two pull-out arms which are linearly displaceably mounted on a machine frame. A machine head carrying a saw blade is hinged to the end of the pull-out arms which faces away from the dust collector. If the machine head is now moved during sawing, the dust collector is also moved. When the machine head is pivoted from its rest position above the workpiece into its lowered working position, however, the dust collector remains stationary, since the dust collector, unlike the machine head, is fixed to the linear guide so that the increasing distance is compensated by the flexibility of the hose.

Another solution is the use of telescopic sections of the suction line that can be swiveled into one another. Such an arrangement is shown in European patent EP 2 377 636 B1, which shows a cross-cut slide saw with a fixed dust collection container and movable machine head with saw blade, both connected to each other with the flexible suction line described above.

### SUMMARY

It is therefore an object to find an alternative solution to overcome the disadvantages of conventional saws of the type described above.

This object is achieved by a saw as disclosed herein.

In the case of a saw, in particular a chop or cross-cut saw, cross-cut slide saw or slide compound miter saw, having a machine head which is mounted on a machine frame so as to be pivotable in a vertical plane and so as to be for sawing pressable downwards from a rest position, and which carries a saw blade rotating for sawing, and having a dust collector, which serves to hold the chips and dust produced during sawing and which is connected to a connection socket on a saw blade cover mounted above the saw blade on the machine head, a linear guide is provided on the machine frame, in accordance with the invention, in which a carriage is slidably accommodated, on which the dust collector is arranged, which is connected to the connection socket via a bendable or flexible connecting line.

According to an aspect of the invention, the dust collector sits on or in the carriage, which is mounted on the machine frame so as to be slidable along the linear guide so that the dust collector is not tilted into a position vertically above the saw blade when the machine head is pressed down, but instead makes a linear displacement movement. According to a further aspect of the invention, the bendability or flexibility of the connecting line between the suction nozzle and the dust collector compensates for the different directions of movement of the machine head or saw blade cover, which is pivoted downwards, on the one hand, and the dust collector, on the other. The connecting line is so flexible that it does not buckle when the machine head is swiveled, but instead pulls or presses the dust collector.

The dust collector is therefore on the one hand attached linearly movable to the machine frame, whereas the machine head carrying the saw blade is on the other hand hinged to the machine frame, so that the dust holder and the machine head perform movements with different directions of movement relative to the machine frame when the machine head is pressed down for sawing, namely a linear displacement of the dust collector relative to the machine frame and the machine head hinged thereto and a pivoting movement of the machine head relative to the machine frame and the dust collector mounted thereon linearly displaceable. The flexible connecting line connects the machine head to the dust collector and compensates for the change in length due to the different directions of movement.

According to an aspect of the invention, to ease the movement and low air supply required for chip extraction, the linear guide is arranged in such a way that it runs horizontally when the machine frame rests on a horizontal base.

The carriage can be designed as a frame which surrounds the dust collector on several sides, wherein the dust collector is formed as a dimensionally unstable dust collection bag. This allows the dimensionally unstable dust collection bag to be stretched and held in place.

Alternatively, the dust collector can be designed as a dimensionally stable container, for example as a plastic container, so that such a stretching and thus the frame is not absolutely necessary. The carriage can then simply consist of a base for the container, which is preferably made of plastic. On the other hand, it would also be conceivable to form the carriage and the container in one piece. Even with a dimensionally stable container, however, a frame surrounding it on several sides would be conceivable.

The dimensionally stable dust container can have a removable side wall or an access opening that can be closed with a flap to remove the collected chips, especially on its underside. An advantageous design would be, for example, a drawer or closing plate guided in two grooves.

The linear guide can have two parallel guide grooves, for example in the form of two guide rails which are attached to or near the swivel joint on which the machine head is pivotably mounted on the machine frame, and which are fixed to the machine frame and each have a longitudinal groove. The carriage can then have four journals or guide bodies, two at its front and rear end, respectively, which project away from each other and project with their free ends outwards into the guide groove there and are thus guided there. This ensures that the carriage and thus the dust container or dust collection bag mounted on it perform a purely translational movement.

The bendability or flexibility of the connecting line can be achieved, for example, by the fact that it is designed as a bellows or rubber hose.

In particular with a dust collector formed as a dust collection bag, a zipper can be provided to allow access to the inside of the dust collection bag for emptying.

The dust collector can be horizontally pivotable and releasably secured in the frame against horizontal pivoting. For example, swivel joints could be mounted between two vertical frame struts in front of and behind the dust collection bag, on which the dust collection bag is mounted horizontally rotatable or pivotable on the frame. The zipper could then be located in a place of the dust collection bag which, when the saw is used, is located at the bottom in the area facing the bottom of the carriage and is thus protected. To empty the dust collection bag, it can then be swung out horizontally until the zipper is accessible.

Furthermore, it is typical, in particular with a dust container designed as a plastic container and therefore initially air-impermeable, if an additional blower unit is provided, for example in the form of a commercially available PC-12V fan, which generates a draft of air through the dust collector, for which purpose the dust collector designed as a plastic container has typically an opening assigned to the blower unit, which is covered by a filter element and/or one or more deflecting elements, such as a deflecting plate. Such a baffle plate or deflector plate can also be provided at the inlet of the dust container in order to direct the air flow to the bottom of the container first.

The connecting line can be connected directly to the dust collector or to the frame supporting the dust collector via a rotating or clamping ring, wherein the ring can be opened and closed to separate the connecting line from the dust collector unit on the one hand (consisting of the carriage and the dust collector). It would also be conceivable to place the rotating ring on the horizontal swivel axis of the dust collection bag so that it can also be used to horizontally swivel out the dust collection bag into the removal position.

Typically, the dust collector is detachably attached to the carriage and can therefore be removed, especially if it is designed as a dimensionally stable container, so that it can be emptied easily.

### BRIEF DESCRIPTION OF THE DRAWINGS

The invention will now be described with reference to the drawings wherein:

FIG. 1 is a perspective view of a saw in a resting position according to an exemplary embodiment of the invention;

FIG. 2 shows the saw of FIG. 1 in sawing position;

FIG. 3 shows a partial perspective view of the saw shown in FIGS. 1 and 2 in the resting position with the dust bag swiveled out for emptying;

FIG. 4 is a perspective view of a saw in the sawing position according to another exemplary embodiment of the invention;

FIG. 5 is another perspective view of the saw shown in FIG. 4 in the sawing position from the rear side;

FIG. 6 is a partial perspective view of the back of the saw shown in FIGS. 4 and 5; and

FIG. 7 shows the saw of FIGS. 4 to 6 with the dust collector removed.

### DESCRIPTION OF EXEMPLARY EMBODIMENTS

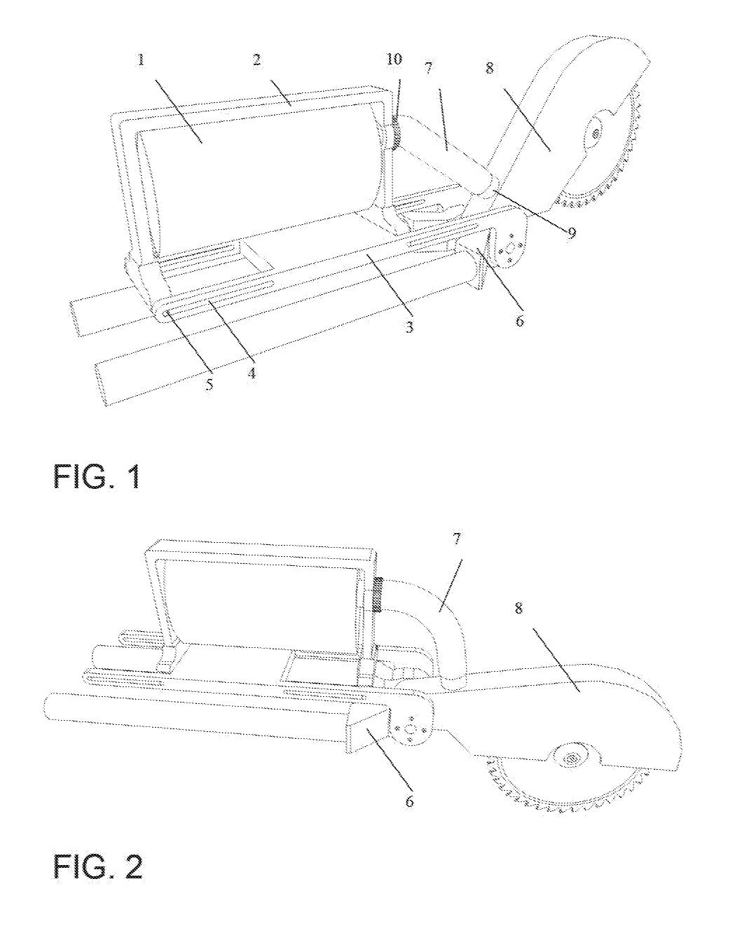

First, reference is made to FIG. 1, which shows a chop saw with a machine frame only partially shown and designated with 6 and a machine head hinged to it, which machine head carries a saw blade with an upper saw blade cover 8. For sawing, the machine head with the saw blade is swiveled downwards from the raised position shown in FIG. 1 to the sawing position shown in FIG. 2. The saw blade cover 8 has a connection socket 9, on which a connecting line 7 leading to a dust collection bag 1 is connected.

To ensure the necessary freedom of movement of the machine head and at the same time to prevent the dust collection bag 1 from pivoting with the machine head, a linear guide 3 is provided on the machine frame 6, consisting of two guide rails with four guide grooves or slotted holes 4, and a slide slidably guided therein, which is designed as frame 2 carrying the dust collection bag 1 and has a pair of pins 5 at its front and rear ends, respectively, guided in the two guide rails. The two guide rails forming the linear guide 3 can be attached to the outside of the swivel head of the machine frame 6, to which the machine head carrying the saw blade is hinged.

The connecting line 7 connecting the dust collection bag 1 with the machine head or the connecting socket 9 on the saw blade protection 8 can be designed as a bellows or folding tube or, as shown, as a rubber hose, so that it does not buckle when the machine head moves up or down, but simply yields slightly due to its bendability or flexibility, but translates the swivel movement of the machine head into a translation movement of the dust collecting bag 1 along the linear guide 3, which together with the frame 2 forms a dust collecting unit.

If the machine head is pressed down, the flexible connecting line 7 pulls the dust collection bag 1 in frame 2 horizontally in the direction of the machine head (FIG. 2). When the machine head is returned to its starting position, connecting line 7 pushes the dust collection bag 1 and the frame 2 horizontally back into their starting position (FIG. 1).

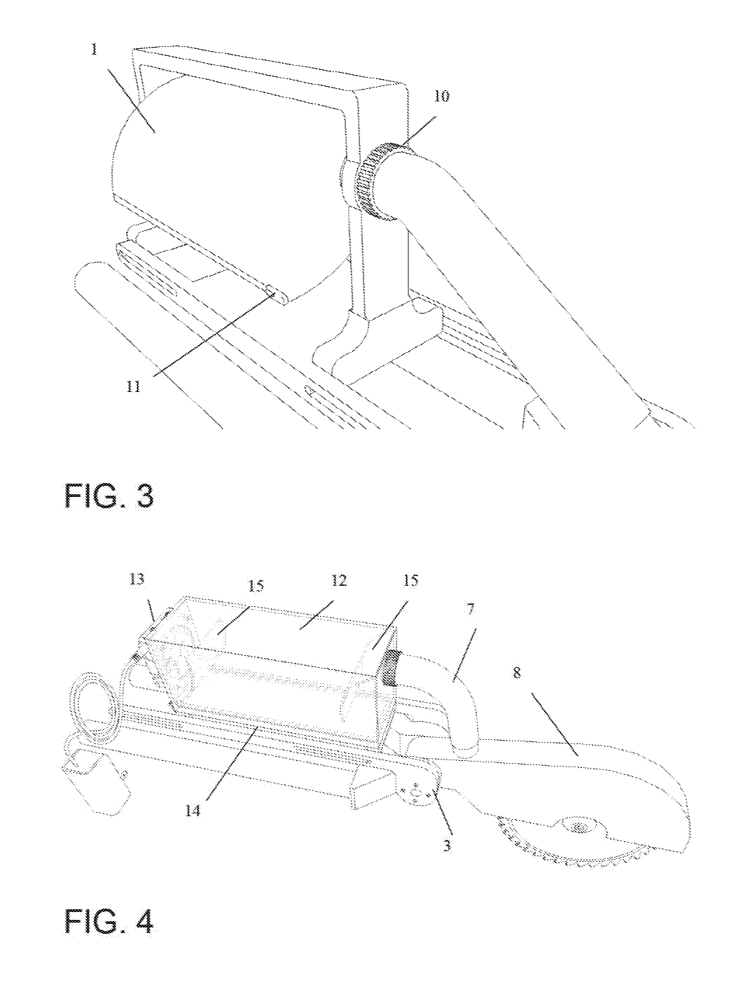

To empty the dust collection bag 1, it can be turned from its working position shown in FIG. 1 into an emptying position shown in FIG. 3, which is swiveled horizontally as compared to the working position. For this purpose, a rotating ring 10 is provided which is connected to an axle which carries the dust collection bag 1. The rotating ring allows the dust collecting bag 1 to be swiveled from its working position shown in FIG. 1 to the emptying position shown in FIG. 3 and back. On its lower side in the working position, the dust bag 1 has a zipper 11, which typically extends along its entire length and can be opened to empty the dust bag.

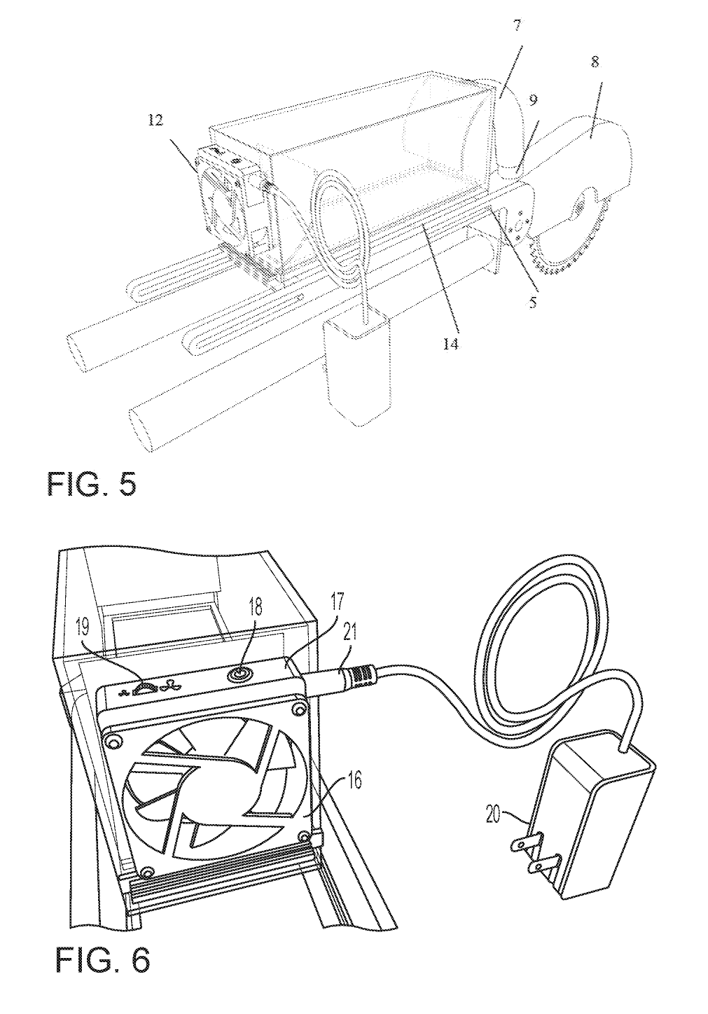

Another exemplary embodiment of the invention is shown in FIGS. 4 to 7. The dust collection bag 1 shown in FIGS. 1 to 3, which is dimensionally unstable and therefore held by a frame 2, has been replaced by a dimensionally stable, optionally cuboid-shaped container 12, which can optionally be made of transparent and impact-resistant plastic. Instead of a frame surrounding the dimensionally unstable dust collection bag on several sides, a carriage 14 can be provided here, on which the dust collection container 12 is simply placed and fastened there in a manner as well known in the art, for example by clip connections or the like. The carriage 14, which only has a base plate instead of a frame, can in turn be guided by four pins 5 in a linear guide 3, which, like the connecting line 7, corresponds to the exemplary embodiment of the invention already explained in connection with FIGS. 1 to 3.

A blower unit 13 in the form of a standard 12 V DC PC fan 16 with a control unit 17, an on/off switch 18 and a speed controller 20 is attached to the plastic container, at the rear end of it, i.e., opposite the machine head, and generates an additional air flow through the dust collection container 12 through a circular opening in the rear wall of the dust collecting container 12. The PC fan 16 and the control unit 17 are supplied, for example, via a wall transformer 20, which supplies the necessary DC voltage. The wall transformer 20 has a corresponding plug 21, which is connected to a connection socket of the blower unit 13. Alternatively, a battery-powered or battery-operated version of the blower unit would also be conceivable.

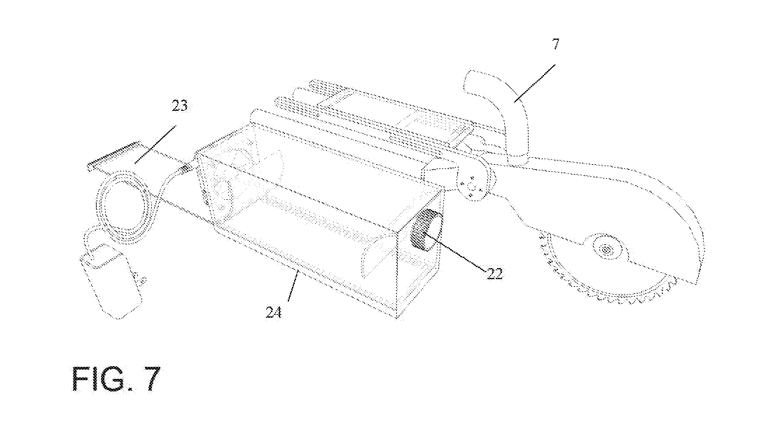

The dust collection container 12 is connected to the flexible connecting line 7 via a clamping ring 22. If the clamping ring 22 is turned accordingly, the connecting line 7 can be pulled off. The dust collection container 12 can then be removed from the carriage 14, as shown in FIG. 7, to empty the dust collection container 12. For this purpose, the dust collection container has a bottom side designed as a drawer 23, which is guided in two longitudinal grooves 24 in the vertical side walls of the dust collection container 12, so that the dust collection container 12 can be emptied.

The dust collection container 12 also has two curved deflecting plates 15 (FIG. 4) that prevent dust and chips from being blown back out directly through the hole in the rear wall leading to the fan opening 13.

It is understood that the foregoing description is that of the exemplary embodiments of the invention and that various changes and modifications may be made thereto without departing from the spirit and scope of the invention as defined in the appended claims.

What is claimed is:

1. A saw, in particular a cross-cut saw, cross-cut slide saw or slide compound miter saw, comprising:
a machine head which is mounted on a machine frame so as to be pivotable in a vertical plane and which is mounted on the machine frame so as to be, for sawing, pressable downwards from a rest position and carries a saw blade rotating for sawing, and having a dust collector, which serves to receive the chips and dust produced during sawing and which is connected to a connection socket on a saw blade cover mounted above the saw blade on the machine head,
wherein the dust collector is arranged on a carriage displaceably received in a linear guide,
wherein the dust collector is connected to the connection socket via a flexible connecting line,
wherein the linear guide is provided on the machine frame in such a way that when the machine head is pressed down, the dust collector is not tilted into a position vertically above the saw blade, but makes a linear displacement movement,
wherein when the machine head is pressed down the saw blade cover on the one hand and the dust collector on the other hand move relative to the machine frame, and
wherein the bendability or flexibility of the connecting line between the connection socket and the dust collector compensates for the different directions of movement.

2. The saw according to claim 1, wherein the linear guide is arranged so that it runs horizontally when the machine frame rests on a horizontal support.

3. The saw according to claim 1, wherein the carriage is constructed as a frame which surrounds the dust collector on several sides, and
wherein the dust collector is designed as a dimensionally unstable dust collection bag.

4. The saw according to claim 1, wherein the dust collector is formed as a dimensionally stable container, in particular of plastic, and is arranged in one piece with the carriage or on the carriage.

5. The saw according to claim 4, wherein the container has a removable side wall, in particular on its underside, preferably in the form of a drawer guided in two grooves.

6. The saw according to claim 1, wherein the linear guide has two parallel guide grooves and the carriage has two journals at its front and rear end, respectively, projecting away from one another and projecting into the two guide grooves.

7. The saw according to claim 1, wherein the connecting line is designed as a bellows or rubber hose.

8. The saw according to claim 1, wherein a zipper for removing dust is attached to the dust collector.

9. The saw according to claim 8, wherein the dust collector is mounted in the frame so as to be horizontally pivotable and detachably secured against horizontal pivoting, the zipper being accessible in a swung out removal position of the dust collector and not in an operating position.

10. The saw according to claim 1, wherein a blower unit, for example a 12V fan, is provided, which generates a draft of air through the dust collector, the blower unit preferably being arranged on the side of the dust collector facing away from the saw blade.

11. The saw according to claim 10, wherein the dust collector has an opening associated with the blower unit which is covered by a filter element and/or a deflector element.

12. The saw according to claim 1, wherein the connecting line is connected to the dust collector via an openable and closeable clamping or rotating ring.

13. The saw according to claim 1, wherein the dust collector is detachably attached to the carriage and is therefore removable.
